(19) United States
(12) Patent Application Publication
(10) Pub. No.: US 2017/0331717 A1
(43) Pub. Date: Nov. 16, 2017

(54) MODELING A MULTILAYER NETWORK

(71) Applicant: ARIA NETWORKS LIMITED, Bath (GB)

(72) Inventor: Jay PERRETT, Chippenham, Wiltshire (GB)

(73) Assignee: ARIA NETWORKS LIMITED, Bath (GB)

(21) Appl. No.: 15/531,353

(22) PCT Filed: Nov. 27, 2015
(86) PCT No.: PCT/GB2015/053634

§ 371 Date: May 26, 2017

(30) Foreign Application Priority Data
Nov. 28, 2014 (GB) 1421159.3

(51) Int. Cl. H04L 12/751; H04L 12/781; H04L 12/24

(52) U.S. Cl. CPC H04L 45/02; H04L 41/145; H04L 45/52

(57) ABSTRACT

A system for optimising routing of traffic in a multilayer telecommunications network is described. The multilayer telecommunications network comprises a first layer and a second layer in which a subset of links in the first layer are served by the second layer. The system is configured to receive network topology data describing topology of the first layer and of the second layer and to receive service requirements data describing data transport services required of the multilayer telecommunications network. The system is configured to generate a flat model by modelling the multilayer telecommunications network as a single-layer telecommunications network, the flat model being based on the network topology data and excluding links of the first layer that are served by the second layer. The system is configured to optimise routing of traffic through the single-layer telecommunications network based on the service requirements data and the flat model using a routing engine, and to convert the optimized routes through the single-layer telecommunications network into first-layer optimized routes through the first layer of the multilayer telecommunications network and second-layer optimized routes through the second layer of the multilayer telecommunications network.

### FIELD OF THE INVENTION

The invention relates to systems and methods for modelling a multilayer network. The invention is particularly useful for optimising a multilayer network to ensure that services are routed efficiently for optimised service provision within a set of constraints from the perspective of the network as a whole. For example, the invention would be suitable for modelling and optimising service provision using a data transport network having IP and optical layers.

### BACKGROUND

There is a need to optimise multilayer networks so that services can be routed through them efficiently to provide as many services as possible within constraints, whilst maintaining a proper level of service. For example, a service to be routed may have a bandwidth requirement and a maximum delay or ‘latency’ requirement, and may require a back-up or secondary route to protect against failure of a primary route. A range of requirements must be balanced against various constraints such as cost constraints in order to find an optimum solution for the network.

Known methods for modelling single layer networks may be applied to modelling multilayer networks by first optimising one of the multiple layers and then ‘rolling’ the optimised solution up and down to the other layers of the network. The resulting solution for the multilayer network may be improved iteratively by ‘evolving’ the solution to arrive at an optimised multilayer network. In this approach, the optimised single layer is used as a seed for optimising the multilayer network.

However, this approach is still based on optimising just one of the layers of the multilayer network. It would be beneficial to develop a technique for modelling all the layers of the multilayer network together.

It is accordingly an object of the invention to provide an improved technique for modelling a multilayer network.

### SUMMARY OF THE INVENTION

In a first aspect of the invention, a system for optimising routing of traffic in a multilayer telecommunications network is provided. The multilayer telecommunications network comprises a first layer and a second layer in which a subset of links in the first layer are served by the second layer. The system is configured to receive network topology data describing topology of the first layer and of the second layer and to receive service requirements data describing data transport services required of the multilayer telecommunications network. The system is configured to generate a flat model by modelling the multilayer telecommunications network as a single-layer telecommunications network, the flat model being based on the network topology data and excluding links of the first layer that are served by the second layer. The system is configured to optimise routing of traffic through the single-layer telecommunications network based on the service requirements data and the flat model using a routing engine, and to convert the optimized routes through the single-layer telecommunications network into first-layer optimized routes through the first layer of the multilayer telecommunications network and second-layer optimized routes through the second layer of the multilayer telecommunications network.

Preferably, the flat model includes gateways between the first layer and the second layer as links of the single-layer telecommunications network.

Preferably, the system is configured to command the multilayer telecommunications network to route traffic in the first layer according to the first-layer optimized routes and to route traffic in the second layer according to the second-layer optimized routes.

Preferably, the system is configured to receive capacity data describing free capacity of links and nodes of the multilayer telecommunications network and to optimise the routing of traffic based on the capacity data.

Preferably, the system is configured to remove a node or link from the flat model for failure analysis of the multilayer telecommunications network.

Preferably, the multilayer network comprises at least one of an IP layer, an Ethernet layer, an optical layer and an optical-electrical-optical layer.

In a second aspect of the invention, a method of optimising routing of traffic in a multilayer telecommunications network is provided. The multilayer telecommunications network comprises a first layer and a second layer in which a subset of links in the first layer are served by the second layer. The method comprises receiving network topology data describing topology of the first layer and of the second layer and receiving service requirements data describing data transport services required of the multilayer telecommunications network. The method comprises generating a flat model by modelling the multilayer telecommunications network as a single-layer telecommunications network, the flat model being based on the network topology data and excluding links of the first layer that are served by the second layer. The method comprises optimising routing of traffic through the single-layer telecommunications network based on the service requirements data and the flat model using a routing engine, and converting the optimized routes through the single-layer telecommunications network into first-layer optimized routes through the first layer of the multilayer telecommunications network and second-layer optimized routes through the second layer of the multilayer telecommunications network.

Preferably, the flat model includes gateways between the first layer and the second layer as links of the single-layer telecommunications network.

Preferably, the method comprises commanding the multilayer telecommunications network to route traffic in the first layer according to the first-layer optimized routes and to route traffic in the second layer according to the second-layer optimized routes.

Preferably, the method comprises receiving capacity data describing free capacity of links and nodes of the multilayer telecommunications network and optimising the routing of traffic based on the capacity data.

Preferably, the method comprises removing a node or link from the flat model for failure analysis of the multilayer telecommunications network.

Preferably, the multilayer network comprises at least one of an IP layer, an Ethernet layer, an optical layer and an optical-electrical-optical layer.

In a third aspect of the invention, there is provided computer program code which when run on a computer causes the computer to perform a method according to the second aspect.

In a fourth aspect of the invention, there is provided a carrier medium carrying computer readable code which when run on a computer causes the computer to perform a method according to the second aspect.

In a fifth aspect of the invention, there is provided a computer program product comprising computer readable code according to the third aspect.

In a sixth aspect of the invention, there is provided an integrated circuit configured to perform a method according to the second aspect.

In a seventh aspect of the invention, there is provided an article of manufacture for detecting a selected mode of household use, the article comprising: a machine-readable storage medium; and executable program instructions embodied in the machine readable storage medium that when executed by a programmable system causes the system to perform a method according to the second aspect.

In an eighth aspect of the invention, there is provided a device comprising: a machine-readable storage medium; and executable program instructions embodied in the machine readable storage medium that when executed by a programmable system causes the system to perform a method according to the second aspect.

### DESCRIPTION OF THE DRAWINGS

The invention will now be described in detail with reference to the following drawings of which:

FIG. 1 is a flow chart showing a method of modelling a multilayer network in accordance with an embodiment of the invention;

FIG. 2 is a schematic diagram of an input topology of a two-layer network having an optical layer and an IP layer that can be modelled using the method of FIG. 1;

FIG. 3 is a schematic diagram representing different types of nodes of the two-layer network and the way in which services are routed through each of them;

FIG. 4 is a schematic diagram illustrating possible routes through a section of the two-layer network;

FIG. 5 is a schematic diagram of a rack housing the network section;

FIG. 6 is a block diagram illustrating, in a hierarchical structure, the capacity of the rack;

FIG. 7 is a schematic diagram of the two-layer network after it has been flattened using the method of FIG. 1;

FIG. 8 is a table of an IP demand matrix showing services required of the IP layer;

FIG. 9 is a table of an optical demand matrix showing services required of the optical layer;

FIG. 10 is a schematic diagram of the flattened network annotated to show different candidate paths through the flattened network;

FIG. 11 is a schematic diagram showing how a service journeys between the optical and IP layers when travelling along a particular candidate path;

FIG. 12 is a schematic diagram showing how a service journeys between the optical and IP layers when travelling along a further candidate path;

FIG. 13 is a flow chart showing in detail the step of evolving candidate solutions according to the method of FIG. 1;

FIG. 14 is a schematic diagram of the flattened network annotated to show an optimum path comprising primary and secondary paths through the flattened network;

FIG. 15 is a schematic diagram of a service journeying between the optical and IP layers when travelling along the primary and secondary paths of the optimum path;

FIG. 16 is schematic diagram of links in the optical and IP layers associated with the optimum path;

FIG. 17 is a schematic diagram of an optimised multilayer network topology based on the optical and IP layer links of FIG. 16; and

FIG. 18 is functional block diagram of a system for modelling a multilayer network in accordance with an embodiment of the invention.

Throughout the drawings, like reference symbols refer to like features or steps.

### DETAILED DESCRIPTION OF THE INVENTION

Networks are modelled as a set of nodes with links between them in which different types of nodes and links provide different capabilities and enable different services. For example, in telecommunication networks, network nodes are provided at base stations and radio transceiving user devices, and network links include over-the-air radio paths and wired Ethernet connections between main base stations. In a data transport network, nodes typically include servers, user devices and IP routers, and links are provided by pure IP connections, wired Ethernet connections, optical fibre cabling and so on.

Typically, networks have multiple layers corresponding to the multiple forms a signal can take and the different ways in which a signal is propagated. In the telecommunications example, the over-the-air radio offering may be considered as one layer, whilst the wired Ethernet offering may be considered as another layer. The different layers of a multilayer network interface with each other through gateways which connect a node from one layer with a node of another layer. For example, a telecommunications base station might transmit and receive radio signals, whilst also being connected to the Ethernet. In this case, the base station houses a node of the radio layer, a node of the Ethernet layer, and a gateway between these two nodes. Similarly, a data transport network may comprise an Internet protocol (IP) layer, an Ethernet layer and an optical layer. In some cases, the optical layer is itself considered as comprising two layers, the optical channel (OCh) or ‘pure’ optical layer, and the optical management system (OMS) layer which includes optical and electrical components such as those for amplifying and reshaping optical signals to correct signal attenuation and reduce noise. A data centre may also be modelled as a network and may, for the purposes of embodiments of the invention, be treated as a layer of a multilayer network.

There is a range of different types of nodes and links with different properties depending on the type of network they are in and the types and amount of traffic supported. The properties of nodes and links also depend on the particular layer the node or link is in, and on the function of the node or link within that layer. For example, a node acting as a switch or multiplexer may be associated with a particular capacity, cost and power requirement. Similarly, a link such as an optical link provided as a fibre optic cable may be able to support a certain number of wavelength bands or channels and may have a particular latency and a particular cost. Using this information about the nodes and links of a network, a map or topology of the network can be built up to represent the nodes and links present, the properties of those nodes and links, and the connections and relationships between them. This style of representation is often referred to as a network diagram.

For a multilayer network, the network diagram typically comprises a stack of horizontal layers, one on top of the other. The order of the layers in the stack reflects the functionality of the layers and the relationships between them. Usually, in a multilayer network some of the links in a certain layer are served by the links of another layer, meaning that in order for a signal to traverse a link in the served layer it must start in the served layer, go down to the serving layer, travel along a number of links in the serving layer, and finally return up to the served layer arriving at a second node in that layer. Thus, there is a link in the served layer but it is served by a serving or ‘lower’ transport layer. In such a case, the served layer is higher in the stack and the transport layer is below. It will be appreciated that a serving layer may itself be served by a yet lower layer of the multilayer network if there are three or more layers.

The connections between layers are provided by gateways which connect a node of an upper layer with a node of a lower layer. Thus, on a network diagram of a multilayer network, gateways may be represented by a vertical line connecting nodes of different layers. For example, a network diagram showing the topology of a data transport network comprising an IP layer served by an Ethernet layer would show the IP layer as the upper layer and the Ethernet layer as the lower layer, and IP-Ethernet gateways would be represented by vertical lines between them.

A representation of a network topology such as this may be used as an input for various modelling processes for interrogating a network, testing a new network design, and performing scenario exploration such as failure analysis. For example, network topologies may be inputted into various processes for determining an optimum route through a network for a particular service requirement, or for determining an optimum set of routes based on a large set of service requirements. In some examples a network topology might include one or more multilayer nodes—i.e. one or more nodes having functionality of two or more layers. For example, a device in a data transport network might have both IP and Ethernet functionality and as a result is a dual layer node. In this case, the dual layer node is treated as two nodes, one in the IP layer and one in the Ethernet layer, connected by a gateway.

A method of determining an optimum set of routes across a multilayer network will now be described. This method is useful for optimising the delivery of a set of requirements, provided in the form of a demand matrix, using a multilayer network topology as an input to the process.

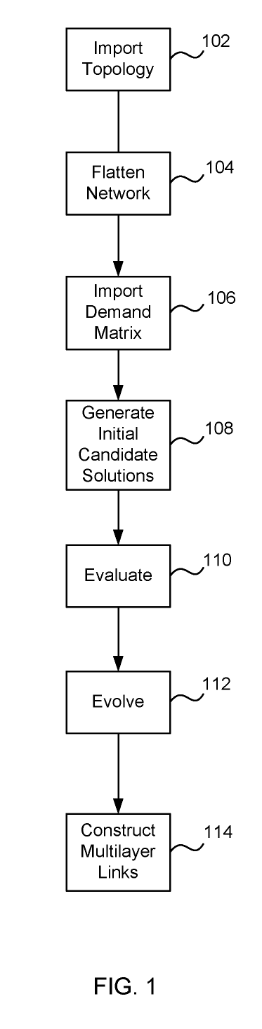

Referring to FIG. 1, an input topology of a multilayer network is imported at step 102. The input topology represents a multilayer network that either already exists and is undergoing some form of analysis such as failure analysis, or a multilayer network that is in the early stages of design and has not yet been built. In the case of network design, the links of the input topology may for example represent rights of way where fibre optic cabling and other network infrastructure may be laid. In the case of an existing network undergoing failure analysis, the input topology may represent a modified version of the existing network, such as a version with at least one link missing for failure analysis. In another example the input topology may represent an existing network and the method may be used to determine an optimum subset of the network to rent from the network owner.

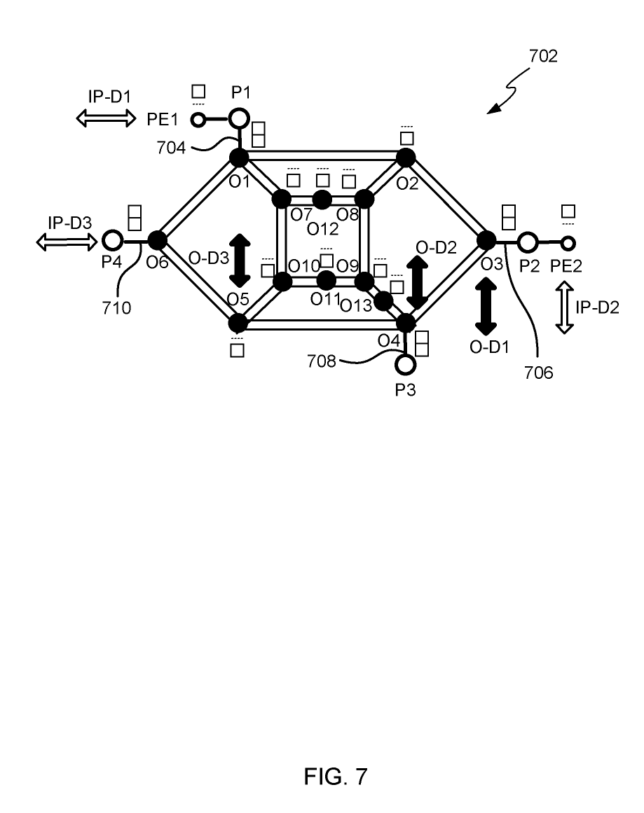

Once the input topology has been imported, it is ‘flattened’ at step 104. Flattening is a modelling step that collapses the multilayer network into a single ‘rich’ layer. This process, which will be described further below in relation to FIG. 7, is a way of treating a multilayer network as a single layer network. It enables modelling and optimising techniques developed for single layer networks to be applied to all the layers of a multilayer network together. In this approach, every layer of the multilayer network is optimised simultaneously by a single process, rather than one layer being optimised and the optimisation of the other layers being based on that one optimised layer.

As shown in FIG. 1, when the network has been flattened a demand matrix is imported at step 106. The demand matrix comprises a set of service requirements as an input to the optimisation process. It is desired not only to route the services through the multilayer network to satisfy the demand matrix, but also, even after the service requirements have been meet, to further iterate the solution to find an optimum routing arrangement. Thus, the optimisation process enables routing to be optimised with respect to certain parameters, for example to minimise cost and to minimise latency. It will be appreciated that the order in which the input topology is imported, the network is flattened and the demand matrix is imported is not important—in some examples, the demand matrix may be imported before the network is flattened, and/or before the input topology is imported. In yet other examples the network may be flattened at a remote server in which case a topology of the flattened network would be imported. In this context a service is a way of expressing how much data is to be sent from a source to a destination. It is not to be confused with individual customer services and is more likely to be an aggregate of these. Thus, in general the demand matrix indicates a set of aggregated customer services rather than a set of individual customer services.

The optimisation process is an iterative process that starts with an initial set of candidate solutions and evolves the set of solutions towards an optimised solution. A set of candidate solutions for starting the process is generated at step 108. Each candidate solution comprises a set of routes or paths across the flattened network, their being one path in each set for each respective service requirement of the demand matrix. Thus, each candidate solution offers a potential routing plan for the services of the demand matrix and can be evaluated with respect to the demand matrix to determine how well the routing plan satisfies the requirements of the demand matrix. Each of the initial candidate solutions is evaluated at step 110 by computing a fitness function whose value indicates how well the candidate solution meets the requirements of the demand matrix and network, e.g. a service may require to be disjoint from another service or have a latency cap and the network may require utilisation on a link to be less than a threshold. This enables the candidate solutions to be compared with each other, for example by ranking them in order of fitness, to establish which candidate solutions best meet the requirements of the demand matrix and which candidate solutions are the weakest solutions.

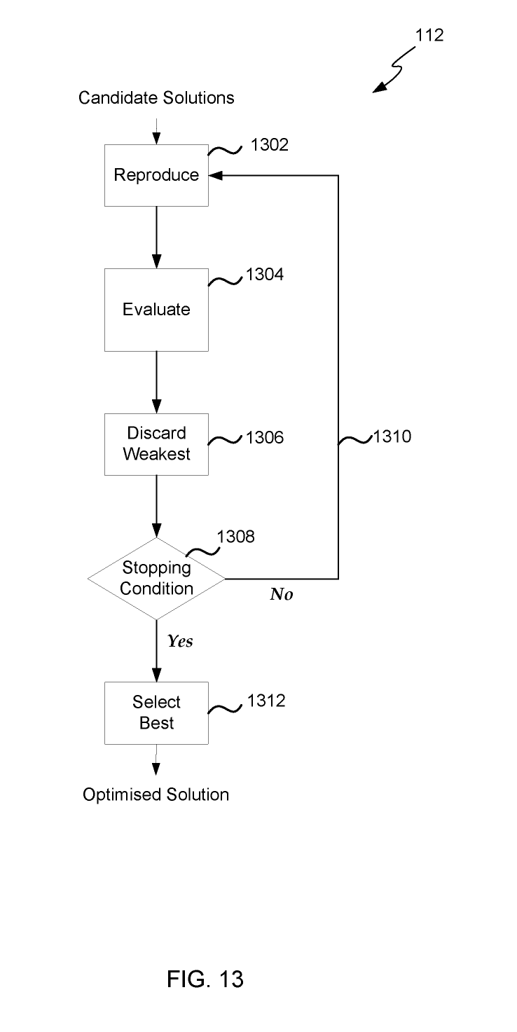

The initial set of candidate solutions, which may for example contain five hundred candidate solutions, is evolved at step 112 towards an optimum solution. This is achieved using an iterative approach that biases the development of the set of candidate solutions towards an optimum. In each iteration, the weakest candidate solutions—i.e. those with the lowest fitness function values—are replaced by new candidate solutions provided that the new candidate solutions have higher fitness functions than the weakest candidate solutions. This tends to increase the quality of the set of candidate solutions as the number of iterations increases, thereby evolving the set so that it becomes increasingly likely that the set includes the optimum solution. The process of evolving the candidate solutions will be explained further below in relation to FIG. 13.

The optimum solution comprises an optimum set of routes based on the input topology and the imported demand matrix. It will be apparent that the optimised set of routes is a set of routes across the flattened network. As such, the solution requires conversion into a set of routes expressed in terms of the original multilayer network so that the solution can be exported in a meaningful way. For this purpose, the optimised routes across the flattened network are projected back onto the layers of the multilayer network. This involves constructing multilayer links at step 114 by building upper layer links when they are served by routes in a lower layer. The result is a representation of a multilayer network in which the routes across each of the individual layers are optimised.

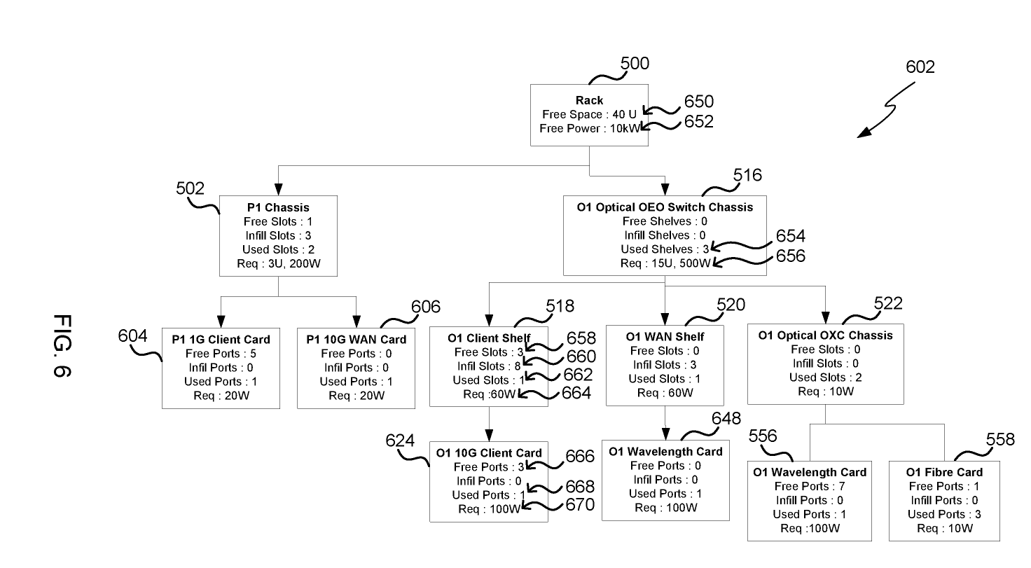

Routing a demand matrix is not sufficient to accurately optimise capacity at each layer in a multilayer network as the properties and constraints at each layer may differ. To accommodate this restriction capacity management is used, the result of which is shown in FIG. 6. Capacity Group Templates (CGT) describe the relationship between different physical and logical capacities in a node and on a link, e.g. the number of regan cards and ports in a node or wavelengths on a link. The service has associated a Service Creation Template (SCT) which describes the service requirements, e.g. require client ports of 1G and transport from A-Z.

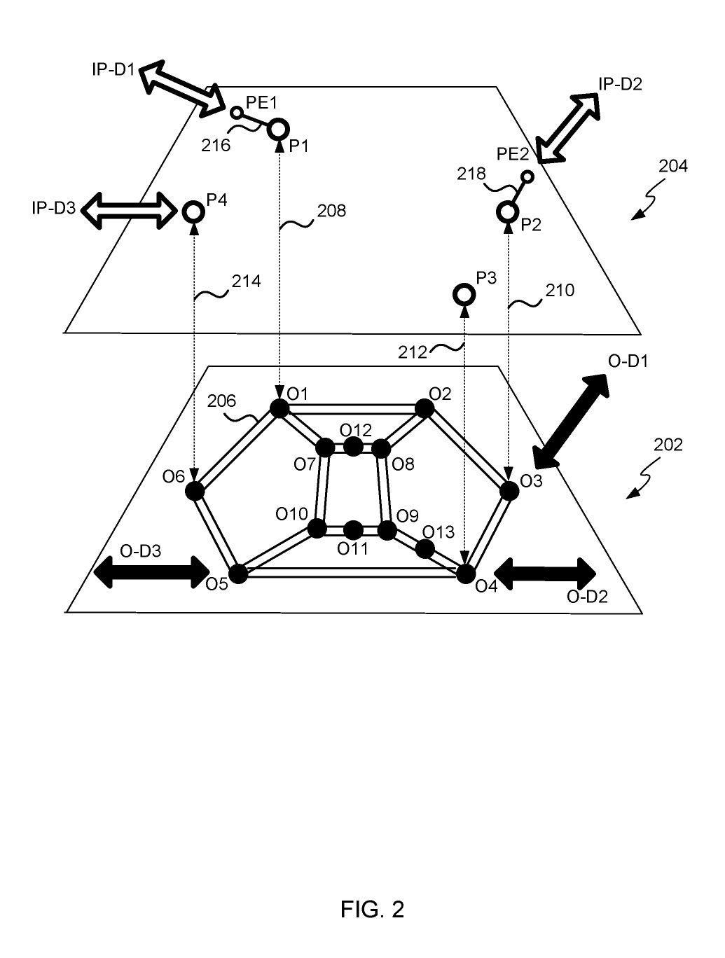

A multilayer network of any type can be optimised in this way. For example, an input topology of a two-layer data transport network having an optical layer 202 and an IP layer 204 is shown in FIG. 2. In this example, the topology represents a potential network that could be built (as opposed to a pre-existing network) and the purpose of modelling the network is to determine how best to build the network within the possibilities represented by the input topology. As such, the links of the optical layer 202, for example link 206, are rights of way (ROWs) where fibre optic cabling could be laid. For example, there might be existing ducts underground and there could be a commercial option for laying cabling. Similarly, the nodes O1 to O13 of the optical layer 202 represent locations where optical node devices of various functionalities could be placed. Together, the nodes O1 to O13 and the ROWs define the input topology of the optical layer 202.

The IP layer 204 has four provider routers or ‘P nodes’, P1 to P4, and two provider edge routers or ‘PE nodes’, PE1 and PE2. The P1 and PE1 nodes are connected by a direct IP link 216, and similarly the P2 and PE2 nodes are connected by a direct IP link 218. A direct IP link is a link that exists in the IP layer and is not served by the optical layer. In this example there are no direct IP links between the P nodes. As a result, links connecting the P nodes must be served by the optical layer and are constructed by projecting the optimised solution back up onto the IP layer. Thus, any links connecting the P nodes will form part of the output of the optimisation process, as described further below.

The IP layer 204 is served by the optical layer 202 via gateways that connect specific nodes of the respective layers. In the input topology of FIG. 2, nodes P1 and O1 are connected by a gateway 208. Similarly, nodes P2 and O3 are connected by a gateway 210, nodes P3 and O4 are connected by a gateway 212, and nodes P4 and O6 are connected by a gateway 214.

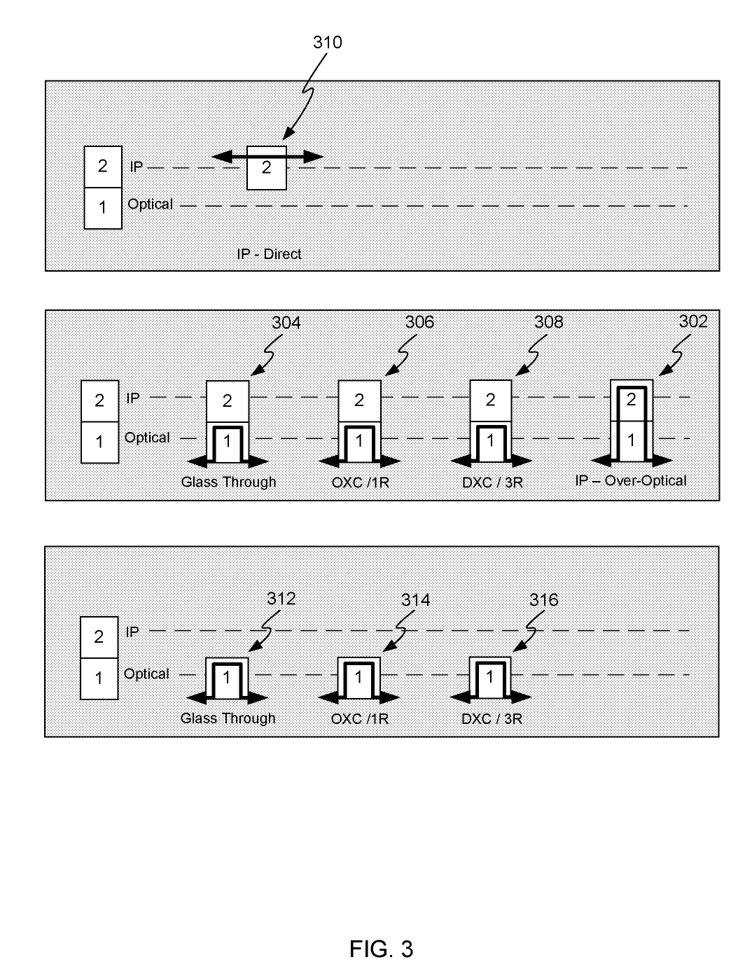

Routing options at different nodes depend on various factors including the functionality of the device provided at the node, the whether there is a ROW or existing link connecting that node to another node, and whether the node is connected to a gateway to another layer. Some routing options of the nodes of the input topology described above are shown in FIG. 3. In this drawing the optical layer is layer 1 and the IP layer is layer 2. For example, in the case of an optical node connected via a gateway to the IP layer, a signal could be routed into the optical node, up to the IP layer, and back down into the optical node where it started and where it can continue elsewhere in the optical layer (routing option 302). Alternatively, although there is a gateway to the IP layer, the signal could stay in the optical layer and pass through the optical node to continue within the optical layer. For example, the signal could pass through a glass through (routing option 304), an optical amplifier or switch (routing option 306), or an optical-electrical-optical (OEO) amplifier or switch (routing option 308). A glass through is an optical network element through which wavelengths can pass optically, and is typically implemented by the coupling of two optical fibres. An optical amplifier could be provided as a 1R in-line optical amplifier which amplifies the signal and retransmits it. This type of amplifier aids signal propagation, although as well as amplifying the signal it also amplifies the noise. By contrast, an OEO amplifier such as a 3R amplifier reshapes, retimes and retransmits the signal, thereby reducing noise and regenerating the signal along the path. Switching nodes such as optical cross connect (OXC) switches and digital cross connect (DXC) switches are also commonly used. DXC switches are OEO devices and an example is an optical add-drop multiplexer (OADM). Direct IP links enable a signal to pass through the IP layer without the need to travel to the optical layer (routing option 310). In the optical layer where there are no gateways to the IP layer, the signal stays in the optical layer for all the glass through, 1 R, OXC, 3R and DXC node types (routing options 312, 314 and 316).

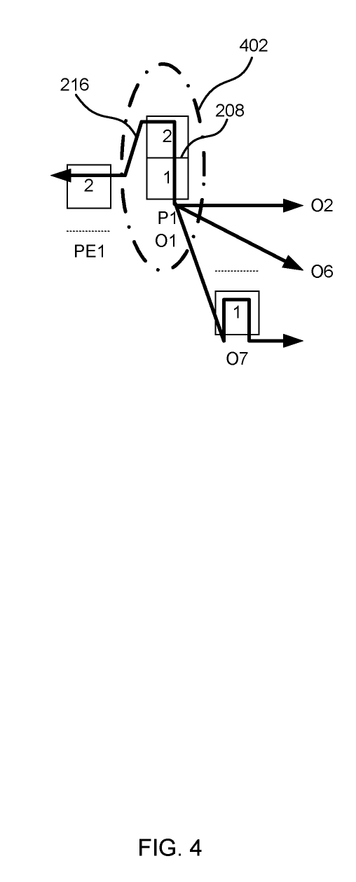

Routing options for signals passing through nodes PE1, P1 and O1 are shown in FIG. 4. Starting at node PE1, a signal may travel from PE1 to P1 along the direct IP link 216 in the IP layer and continue through the gateway 208 to node O1 of the optical layer. At node O1 the signal may continue towards node O2, towards node O6 or towards node O7 along three respective optical links.

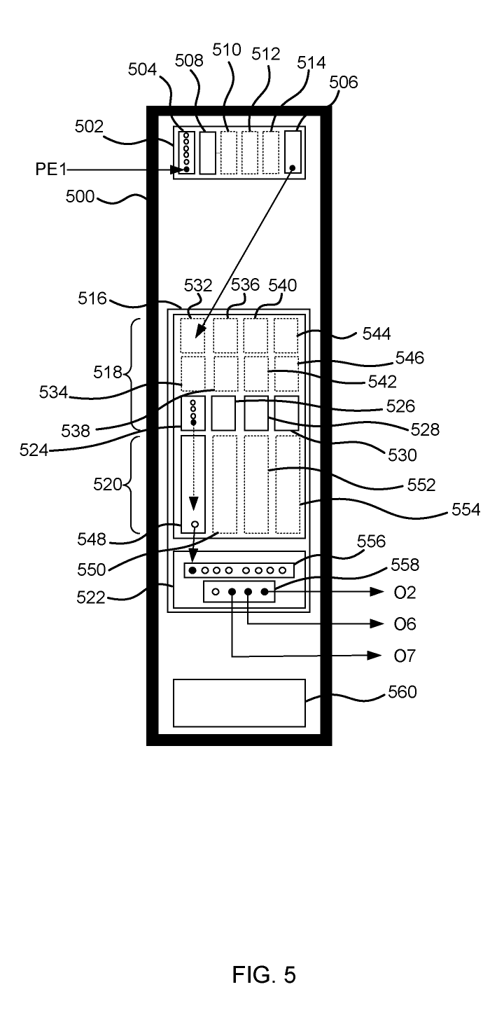

Nodes P1 and O1 are collectively indicated by reference numeral 402 in FIG. 4. Physically, they are located together in a network rack 500, as shown in FIG. 5.

Referring to FIG. 5, node P1 comprises a P1 chassis 502 having two used slots 504 and 506, one free slot 508, and three infill slots 510, 512 and 514. Infill slots are slots that are not currently used or available to be used, but could become available to be used because they can be commissioned.

Referring to FIGS. 5 and 6, the slot 504 is occupied by a P1 1G client card 604 which receives the IP link 216 from PE1. As shown, slot 504 has six ports in total, one of which is used and five of which are free. The slot 506 is occupied by a P1 10G wide area network (WAN) card 606 having one used port for connecting P1 to O1 (i.e. for implementing the gateway 208). The slot 506 has no other ports.

Node O1 comprises an O1 optical OEO switch chassis 516 comprising an O1 client shelf 518, an O1 WAN shelf 520 and an optical OXC chassis 522 also known as an optical patch panel.

The O1 client shelf 518 comprises one used slot 524, three free slots 526, 528 and 530, and eight infill slots 532, 534, 536, 538, 540, 542, 544 and 546. The slot 524 is occupied by an O1 10G client card 624 having one used port and three free ports.

The O1 WAN shelf 520 comprises one used slot 548 and three infill slots 550, 552 and 554. The used slot 548 is occupied by an O1 wavelength card 648 having one used port and no other ports.

The optical OXC chassis 522 comprises an O1 wavelength card 556 having one used port and seven free ports, and an O1 fibre card 558 having three used ports and one free port.

The rack 500 also includes a power supply 560.

A signal arriving from the node PE1 at the used port of the P1 1G client card 504 propagates from the P1 node to the O1 node by traversing the gateway 208. The signal passes through the node O1 and exits through one of the used ports of the O1 fibre card 558 towards the O2, O6 or O7 optical node.

The capacity of the rack 500 and the network elements it contains may be expressed in the form of an inventory or capacity plan. The capacity plan has an intrinsic structure resulting from the interrelationships between the network elements in the rack 500. For example, the O1 10G client card 624 fits inside the slot 524 which itself belongs to the O1 client shelf 518 of the O1 optical OEO switch chassis 516 which is housed inside the rack 500. These types of relationships create a hierarchy such that the capacity of the rack and its contents may be expressed in a hierarchical inventory starting with the rack 500 itself and branching down into each chassis, shelf, card and so on. In the inventory, each network element may be represented by a template which is populated according to how much of the relevant types of capacity it has and any associated requirements such as a power supply, cost, or an amount of space needed in the rack.

For example, a hierarchical capacity plan 602 of the rack 500 is shown in FIG. 6. The rack 500 itself has a capacity of 40U of free space (arrow 650), where ‘U’ is a standard unit of space meaning 1¾ inches of height within the rack. The rack 500 also has a requirement of 10 kW power (arrow 652) for running general rack facilities such as electrical fans to control the temperature inside the rack 500.

The rack 500 is occupied by the P1 chassis 502 and the O1 optical OEO switch chassis 516, as reflected in the hierarchical capacity plan 602. The capacity plan indicates the O1 optical OEO switch chassis 516 as having three used shelves (arrow 654) and as requiring 15U of space and 500 W of power (arrow 656). One of the three shelves is occupied by the O1 client shelf 518 which itself has three free slots (arrow 658), eight infill slots (arrow 660), and one used slot (arrow 662), and requires 60 W of power (arrow 664). It will be appreciated that since the O1 client shelf 518 fits inside the O1 optical OEO switch chassis 516, the O1 client shelf 518 has no space requirement itself as the space is already provided by the chassis 516. Thus, the template for a chassis includes a space requirement whereas the template for a shelf does not. Finally, the used slot 524 of the O1 client shelf 518 (indicated as a capacity of the O1 client shelf 518 by arrow 662) is occupied by the O1 10G client card 624 which has three free ports (arrow 666), one used port (arrow 668), and a requirement of 100 W of power (arrow 670).

In general, capacity may be defined as anything that is consumable by a service. For a node, capacity may include capacity items such as number of slots, number of cards, number of ports, and bandwidth. For a link, capacity may include capacity items such as number of fibre optic cables, wavelength, bandwidth, and number of channels. In both cases, each of the capacity items may be either free, used or infill. Free capacity is capacity that is available to be used—for example a card that is installed but not being used. Used capacity is capacity that is installed but not available to be used because it is already being used. Infill capacity is capacity that could be installed, and therefore could be made available to be used, but is not currently available. For example, a card slot that does not contain a card provides infill capacity.

Once the capacity of each network element is fully characterised, the input topology is flattened (step 104) as follows. All nodes (i.e. nodes O1 to O13, P1 to P4, and PE1 and PE2) and all optical layer links (e.g. link 206) are retained for constructing the flattened network. All these retained links and nodes are laid out as part of a single layer topology. In addition to the retained links and nodes, the gateways 208, 210, 212 and 214 are imported into the single layer topology where each of them takes on the role of a link. Thus, the flattened network 702 includes new ‘inter-layer’ links 704, 706, 708 and 710 as shown in FIG. 7, and the multilayer input topology becomes a single or flattened network with a single layer topology. Since the flattened network comprises nodes from different layers, having different functionalities, the flattening process can be considered as compressing the multilayer input topology into a single rich layer.

The flattened network is used to optimise the routing of services. To determine optimised routes across the flattened network, various requirements of the services—such as bandwidth and cost requirements—are taken into account. For example, routes are determined that provide sufficient bandwidth to deliver the specific services that have been requested, and if applicable financial budget constraints are adhered to where possible. As a result, one of the inputs to the optimisation process is a list of services to be routed including the specific requirements of each of those services. A set of service requirements of this kind may be provided in the form of a demand matrix which has a different row for each requested service and a column for each specified service requirement such as bandwidth.

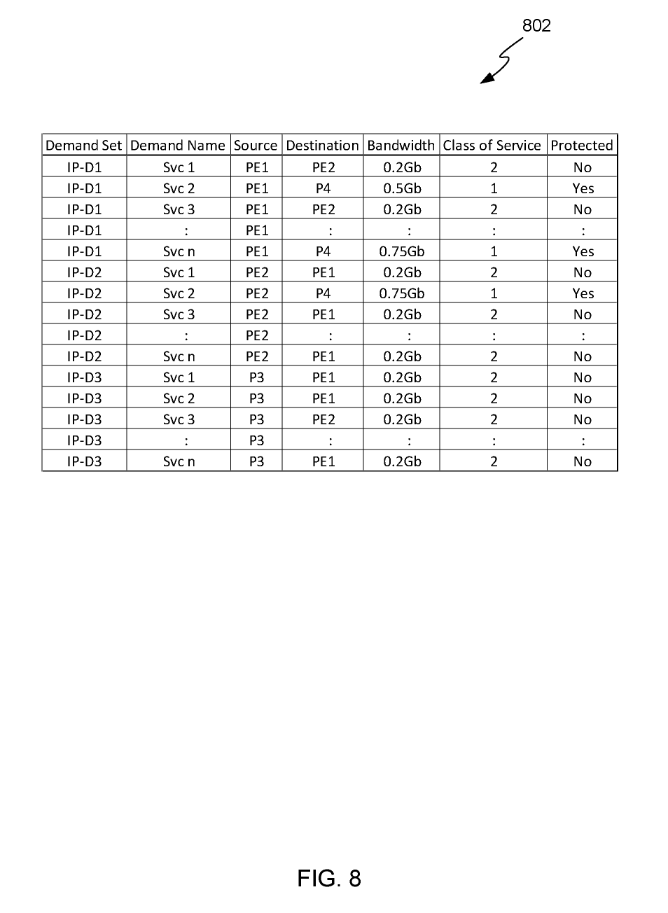

For example, a demand matrix 802 for the IP layer 204 is shown in FIG. 8. In this example the services are grouped into different demand sets according to start node (‘source’). For example, all the services of the first demand set, IP-D1, start at the node PE1. The different services of a particular demand set (i.e. the services sharing a common start node) are labelled Svc 1 to Svc n, where n is the number of service requests in that demand set. It may be that each of the services Svc 1 to Svc n has been requested by a different customer. In any case, for each service the demand matrix indicates the destination node, the required bandwidth, the class of service, and whether the service is to be protected. The required bandwidth is in units of giga bits per second (‘Gb’) and represents a minimum rate of data transmission. Any route through the network is only as fast as its weakest link, so every network element along a proposed route must satisfy the minimum bandwidth requirement. Class of service is a parameter that is typically defined commercially, for example by the network operator, to indicate different tariffs of service and associated levels of service. For example, if the network is busy and resources are constrained, available bandwidth may be made available to more expensive class 1 services in preference to cheaper class 2 services. This would result in class 1 services being less likely to be delayed than class 2 services. Class 2 services might be more likely to have high latency when there is heavy traffic on the network. Protection refers to whether a service requires a back-up route to provide protection in the event that the primary route fails. Taking service Svc 1 of IP-D1 as an example, this service is required to be routed from PE1 to PE2 with a bandwidth of 0.2 Gb, a class of service of 2, and a back-up or secondary path being available.

The requirements of particular services may be categorised into hard constraints and soft constraints. Hard constraints either must be satisfied for the service not to fail or are otherwise defined as being a hard constraint by the customer. Although soft constraints might not be critical to the delivery of the service, they are important for defining an optimum solution. For example, hard constraints may specify a minimum bandwidth and a maximum delay. Soft constraints may specify that cost and delay should be minimised or that OSNR should be maximised.

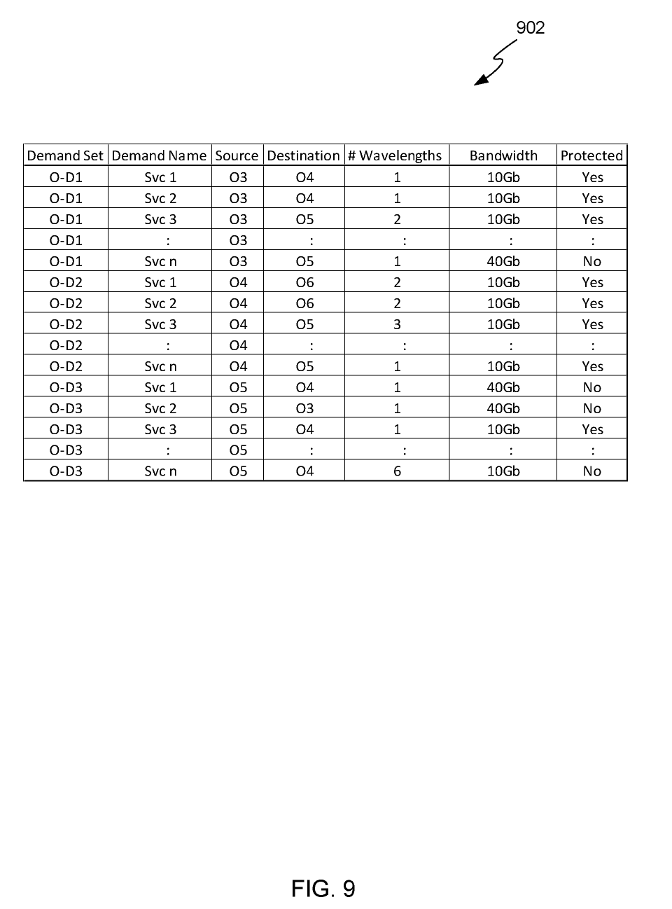

Given that the IP layer 204 is served by the optical layer 202, it will be appreciated that the IP demand matrix 802 intrinsically implies demands on the optical layer 202. Notwithstanding these implied demands, further demands that are independent of the IP layer 204 may be made on the optical layer 202. Demands of this type are shown in the optical demand matrix 902 of FIG. 9 which is similarly laid out to the IP demand matrix 802. For each service the optical demand matrix 902 indicates the source node, the destination node, and whether the service is protected. However, in the optical demand matrix 902, bandwidth requirements are expressed differently.

In the optical layer 202, to access bandwidth a customer may build or lease certain wavelengths (channels), each channel being associated with a particular bandwidth on a standard channel grid. For example, one channel might have a frequency of 192.5 THz and a bandwidth of 10 Gb and another channel might have a frequency of 197.2 THz and a bandwidth of 40 Gb, the 40 Gb channel being more expensive than the 10 Gb channel. Therefore, if a customer needs 10 Gb of bandwidth, it can build or lease one of the 10 Gb channels. If 40 Gb are required, one of the 40 Gb channels can be build or leased. For 8 Gb, a 10 Gb channel would be suitable; for 15 Gb, two of the 10 Gb channels would be suitable; and for 30 Gb, if three of the 10 Gb channels are more expensive than one 40 Gb channel, it will be most cost-effective to build or lease a 40 Gb channel than three 10 Gb channels.

Thus, in the optical demand matrix 902, bandwidth requirements are indicated by a combination of the number of wavelengths (‘# wavelengths’) and an associated bandwidth amount. For example, service Svc 1 of demand set O-D1 requires one wavelength having a bandwidth of 10 Gb. This implies that service Svc 1 requires more than 0 Gb and no more than 10 Gb of bandwidth. Taking a further example, service Svc 3 of O-D2 requires three 10 Gb channels—implying that this service requires a bandwidth of more than 20 Gb but no more than 30 Gb.

In order to develop a routing solution that satisfies the service requirements of the IP demand matrix 802 and of the optical demand matrix 902, an initial set of candidate solutions is generated (step 108) and then evaluated with respect to those demand matrices (step 110). Although the combined demand matrix (‘the demand matrix’ hereinafter) makes demands on both the IP and optical layers, it will be appreciated that the candidate solutions provide potential routes through the flattened network that satisfy the multilayer demands. Similarly, it is the routes of the candidate solutions through the flattened network that are evaluated for how well they satisfy the service requirements of the demand matrix and the requirements of the layers technology, e.g. number of wavelengths on a fibre or bandwidth on a link.

In the present embodiment the initial candidate solutions are generated randomly. Each candidate solution comprises a set of proposed routes through the flattened network: one proposed route for each service request (i.e. each row) of the demand matrix. Thus, each candidate solution could be considered as a list of proposed routes, their being one proposed route for each row of the demand matrix. For example, the service requirement Svc 2 of IP-D1 requires a 0.5 Gb class 2 route from PE1 to P4 with a secondary path for protection. Each candidate solution in the initial set of candidate solutions contains a randomly generated proposed route for routing this service, and every other service specified in the demand matrix. Each proposed route may be referred to as a candidate path.

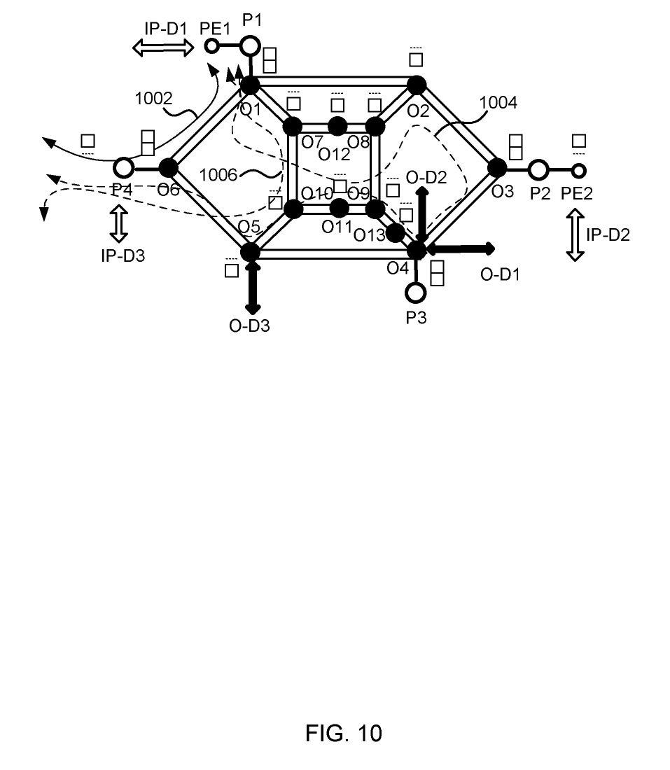

Referring to FIG. 10, four candidate paths are shown. Each of candidate paths 1 to 4 has a primary path and a secondary path. All four candidate paths have the same primary path 1002 but have different secondary paths. The secondary paths of candidate paths 1 to 3 are routed along 1004 but vary according to which functionality (glass through, 1R amplifier, OXC, 3R amplifier, DXC) is placed at each of the optical nodes. The secondary path of candidate path 4 is routed along 1006.

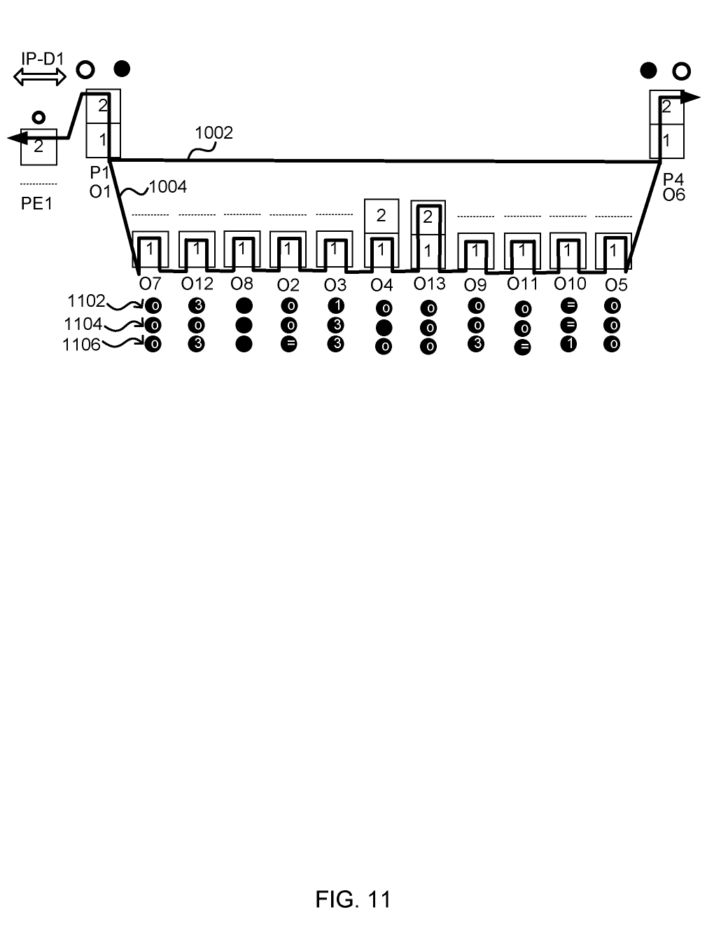

Referring to FIGS. 10 and 11, candidate path 1 has a primary path 1002 and a secondary path 1004 with node functionalities as indicated by reference numeral 1102. Thus, candidate path 1 has a primary path of PE1, P1, O1 (DXC), O6 (DXC), P4 and a secondary path of PE1, P1, O1 (DXC), O7 (OXC), O12 (3R), O8 (DXC), O2 (OXC), O3 (1R), O4 (OXC), O13 (OXC), O9 (OXC), O11 (OXC), O10 (glass through), O5 (OXC), O6 (DXC), P4.

Candidate path 2 has a primary path 1002 and a secondary path 1004 with node functionalities 1104. Thus, candidate path 2 has a primary path of PE1, P1, O1 (DXC), O6 (DXC), P4 and a secondary path of PE1, P1, O1 (DXC), O7 (OXC), O12 (OXC), O8 (DXC), O2 (OXC), O3 (3R), O4 (DXC), O13 (OXC), O9 (OXC), O11 (OXC), O10 (glass through), O5 (OXC), O6 (DXC), P4.

Candidate path 3 has a primary path 1002 and a secondary path 1004 with node functionalities 1106. Thus, candidate path 3 has a primary path of PE1, P1, O1 (DXC), O6 (DXC), P4 and a secondary path of PE1, P1, O1 (DXC), O7 (OXC), O12 (3R), O8 (DXC), O2 (glass through), O3 (3R), O4 (OXC), O13 (OXC), O9 (3R), O11 (glass through), O10 (1R), O5 (OXC), O6 (DXC), P4.

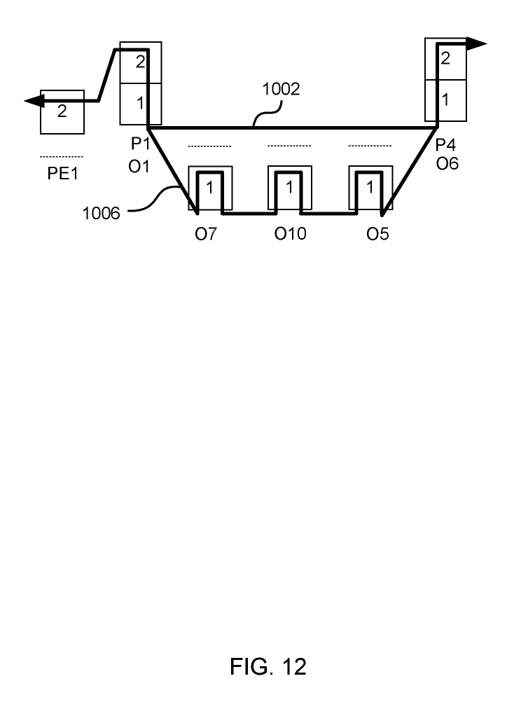

Referring to FIGS. 10 and 12, candidate path 4 has the primary path 1002 and a secondary path 1006 with node functionalities OXC at O7, glass through at O10, and OXC at O5. Thus, candidate path 4 has a primary path of PE1, P1, O1 (DXC), O6 (DXC), P4 and a secondary path of PE1, P1, O1 (DXC), O7 (OXC), O10 (glass through), O5 (OXC), O6 (DXC), P4.

Each of the candidate solutions of the initial set is evaluated at step 110 to provide a measure of how well it meets the requirements of the demand matrix and the constraints of the network. This process can be used to identify the best and worst performing candidate solutions and to rank the candidate solutions in order of performance. The purpose of evaluating the candidate solutions is to determine how well each of them delivers the services that have been requested. As such, the candidate solutions must be evaluated with respect to the demand matrix.

For example, evaluating a candidate solution with respect to the IP demand matrix 802 should include a consideration of the following questions. Does the candidate solution include a route from PE1 to PE2? If yes, does the route have a bandwidth of at least 0.2 Gb? Is there a secondary route from PE1 to PE2 for protection?

The answers to these questions may be used as inputs for a fitness function to determine a fitness value of each candidate solution. This provides a quantitative measure of the performance of each candidate solution and facilitates ranking the candidate solutions in order of fitness. The fitness function may provide a measure of one particular performance parameter, such as bandwidth, or alternatively may take account of two or more performance parameters, for example bandwidth, protection, latency and cost. If there are multiple performance parameters to be evaluated, the fitness function may take account for their relative importance, for example by using weighting coefficients.

To evaluate cost, the fitness function may comprise a function of the difference between the total cost of all routes of a candidate solution and the total budget indicated by a customer. To evaluate latency, the fitness function may comprise a function of the mean difference between delivered latency and requested maximum latency of all routes of a candidate solution. Another example of a performance parameter that may be evaluated is disjointedness. Disjointedness is a measure of how many nodes or links of a candidate solution are shared between different paths of the candidate solution. For example, to evaluate disjointedness, a fitness function may comprise a function of the proportion of the nodes of a candidate solution that are shared between paths of the candidate solution.

In general, it is suitable for the value of the fitness function to be higher for a better performing candidate solution and lower for a weaker candidate solution. For example, the fitness function may take values between 0 and 1, where 1 indicates an optimised solution and 0 indicates a very poor candidate solution.

There is no guarantee that the initial set of randomly generated candidate solutions contains the optimum solution. This would be very unlikely. In order to optimise the routing of services, the candidate solutions are evolved at step 112 using a genetic algorithm towards an optimum solution as follows.

The initial candidate solutions are used as a gene pool that is evolved by an iterative process involving repeated selection of stronger candidate solutions. Thus, with each iteration, the average quality of the candidate solutions increases and it becomes more likely that the gene pool contains the optimum solution.

Referring to FIG. 13, the evolution process (step 112) involves reproducing the candidate solutions at step 1302 using a genetic algorithm to produce one or more ‘child’ candidate solutions from the initial gene pool. The genetic algorithm comprises rules for reproducing the candidate solutions either by mating, mutating or a combination of both.

For example, a pair of child candidate solutions could be created by ‘mating’ two randomly selected parent candidate solutions. The mating process involves swapping corresponding portions of the parent candidate solutions to create two new child candidate solutions. For example, the routes provided by the parent candidate solutions between a particular source node and a particular destination node could be swapped. Alternatively, portions of routes could be swapped, or any other scrambling of the parent solutions could be carried out. Three or more candidate solutions could be scrambled to produce one or more child candidate solutions.

Another method of reproducing is to mutate a parent candidate solution. In this case, a parent candidate solution, which may be randomly selected from the gene pool, is changed in a random, predetermined, or partially random manner. For example, every fifth node of each route could undergo a random change in functionality (e.g. from OXC to glass through). It will be appreciated that by mutating a single parent candidate solution, a single child candidate solution is created.

The creation of child candidate solutions increases the size of the gene pool of candidate solutions. For example, if the initial set of candidate solutions contains five hundred initial candidate solutions and two child candidate solutions are created, the enlarged gene pool contains five hundred and two candidate solutions. At step 1304 the child candidate solutions are evaluated, for example by calculating a fitness function of the type described above. The candidate solutions of the enlarged gene pool are now ranked in order of the value of their fitness function, and if n child candidate solutions were created in the reproducing step 1302, the weakest n of the enlarged gene pool are discarded (step 1306). Following the example above of five hundred initial candidate solutions and two child candidate solutions, the five hundred and two candidate solutions of the enlarged gene pool are ranked by fitness function value and the weakest two of the enlarged set are discarded. Thus, the total size of the gene pool remains constant over time but the quality of the population improves with cycles of the iteration. At worst, an iteration may produce child candidate solutions that are no better than any of the existing candidate solutions. In that case, the new child candidate solutions will be discarded immediately and the quality of the population, which may for example be expressed as a mean fitness function value, will be unchanged. In any other case an iteration will improve the quality of the population thereby increasing the likelihood that the gene pool contains the optimum routing solution.

The evolution process cycles through iterations by reproducing (step 1302), evaluating (step 1304), and discarding the weakest candidate solutions (step 1306) to maintain a constant population size with each cycle and gradually increase the quality of the population. The gene pool may be said to evolve towards an optimum solution as a result of the bias towards better performing solutions introduced by discarding the weakest candidate solutions in each cycle.

The evolution is stopped when a sufficient number of iterations have been applied to reach a predetermined stopping condition 1308. Two suitable stopping conditions are based on reaching a solution sufficiently close to the optimum solution and reaching a gene pool that is likely to contain the optimum solution. One or both of the following stopping conditions may be applied.

In the first approach, a fitness function or a performance parameter such as cost of the optimum solution is estimated, and the best candidate solution in the gene pool is compared to the optimum to determine how close the best candidate solution to date is to the optimum solution. If the fitness function or performance parameter of the best candidate solution to date is sufficiently close to that of the optimum value, the stopping condition is satisfied and the evolution is stopped.

For example, if the performance parameter is cost, the cost of the best solution to date will go down with each iteration, gradually approaching an asymptote which represents the cost of the optimum solution. At some point the cost of the best solution to date will have reached a value within a predetermined percentage, such as 5%, of the optimum cost, at which point the stopping condition is satisfied. After each round of evolution an asymptote is determined. This becomes more reliable with every round of evolution as it is based on more and more data, and can generally be calculated in a meaningful way from, for example, the tenth round onwards. In order to determine an asymptote, the cost improvement as a function of the number of iterations is approximated as a ratio of two polynomials of the same order. Such a rational function, R, may be expressed as follows.

$$R = \frac{{A}_{0} + {A}_{1} \cdot X + {A}_{2} {X}^{2} + … + {A}_{n} {X}^{n}}{1 + {B}_{1} X + {B}_{2} {X}^{2} + … + {B}_{n} {X}^{n}}$$

where X is the number of iterations and A₀, A₁, A₂, . . . , Aₙ, B₀, B₁, B₂, . . . ,Bₙ are constants to be evaluated to fit the data. As the number of iterations becomes large the cost tends to the asymptote which is Aₙ/Bₙ. Thus, in order to determine the asymptote, the constants A₀, A₁, A₂, . . . , Aₙ, B₀, B₁, B₂, . . . ,Bₙ of the polynomials must be computed which can for example be done using a method of least squares. In an example, a best cost to date reaches within 5% of an optimum cost (asymptote) after between 300 and 500 iterations.

In the second approach, the distribution of a fitness function or a performance parameter such as cost is approximated and the value of the fitness function or performance parameter of the best candidate solution to date is compared to the distribution to determine the likelihood that the best candidate solution to date is the optimum solution.

For example, the performance parameter may be cost. The distribution of the cost of all possible routing solutions is approximated based on two assumptions: 1) that the distribution is a normal distribution and 2) that the mean and standard deviation of the initial set of candidate solutions is representative of the mean and standard deviation of all possible candidate solutions. Assumption 2 is justified because the set of initial candidate solutions is generated randomly. Thus, the distribution of the cost of routing solutions is approximated as a normal distribution having a mean and standard deviation the same as the mean and standard deviation of the costs of the initial candidate solutions. The probability that, after any particular number of iterations, the gene pool contains the optimum solution is calculated by iterating the distribution between −∞ and the value of the cost of the best solution to date:

P(we have optimum)=∫_{-∞}^{best to date} distribution

Thus, the stopping condition is satisfied when the likelihood of the gene pool containing the optimum routing solution reaches a predetermined percentage, such as 95%.

However, it will be appreciated that a result of 95% based on a small sample size (e.g. a small number of initial candidate solutions) and/or a small number of iterations is likely to be less reliable that a result of 95% based on a large sample size and a large number of iterations. Therefore, a safeguard may be put in place by way of a minimum probability that the optimum solution has not yet been found (where P(optimum not yet found)=1−P(we have optimum)). The minimum probability may comprise a function of the size of the genepool, the number of iterations that have taken place, the standard deviation of the current genepool (which decreases as the genepool evolves), or any combination of the above. For example, the minimum probability that the optimum solution has not yet been found could be defined as:

$${P ( optimum not yet found )}_{min} = \frac{1}{\sqrt{genepool size + number of iterations}}$$

According to this definition of the minimum probability, once the minimum has been reached, further iterations will increase the likelihood that the gene pool contains the optimum but this will happen much more slowly than on previous iterations. This ensures that for a sufficiently small gene pool size, a higher number of iterations may be required before the stopping condition can reached.

Regardless of how the stopping condition is defined, once it is reached the best solution in the gene pool is selected (step 1312) and outputted as the optimised solution as shown in FIG. 13.

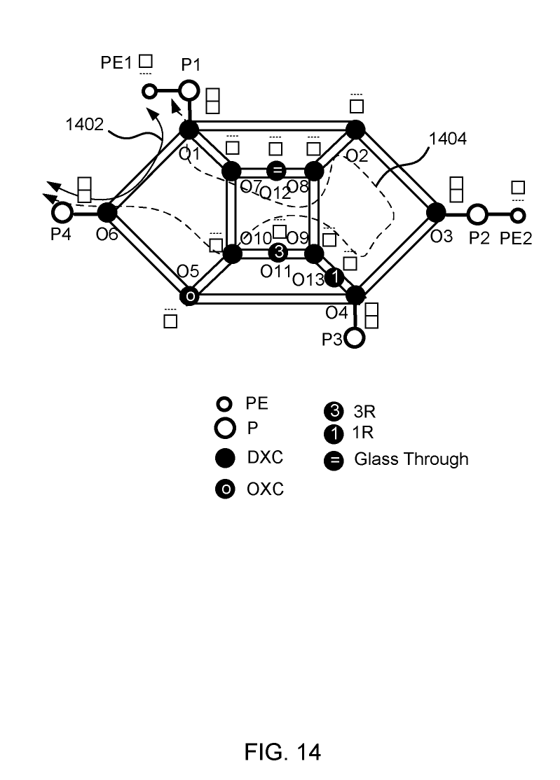

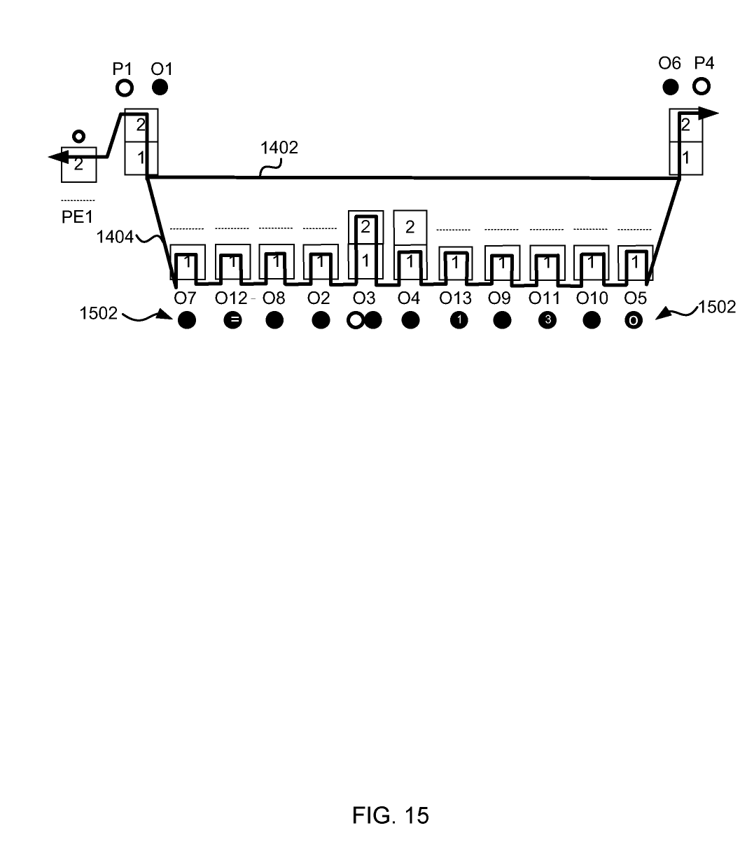

It will be appreciated that the optimum solution comprises a set of paths across the flattened network 702 for satisfying the demand matrix. An example of an optimised path from node PE1 to node P4 of the flattened network 702 is shown in FIG. 14. The optimised path comprises a primary path 1402 and a secondary, back-up path 1404. The primary path may be expressed as PE1, P1, O1 (DXC), O6 (DXC), P4. The secondary path 1404 may be expressed as PE1, P1, O1 (DXC), O7 (DXC), O12 (glass through), O8 (DXC), O2 (DXC), O3 (DXC), P2, O3 (DXC), O4 (DXC), O13 (1R), O9 (DXC), O11 (3R), O10 (DXC), O5 (OXC), O6 (DXC), P4. The same optimised path is represented in FIG. 15.

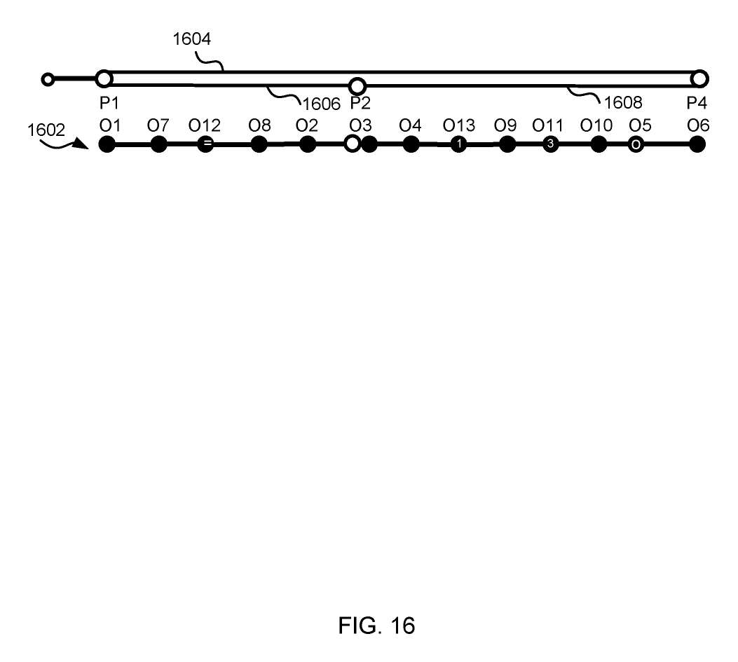

The primary and secondary paths 1402 and 1404 of the optimised path may be projected from the flattened network back onto the different layers of the multilayer network. This results in a definition of the optimised multilayer network in which the routes across each of the individual layers are optimised. For the optical layer, the optical nodes and links of the optimised paths together define the optimised optical layer. For example, the optimised optical layer of the present embodiment includes the nodes and links shown at 1602 in FIG. 16 which together form part of the secondary path 1404. By contrast, the IP layer has some links that exist purely in the IP layer (e.g. between PE1 and P1) while other IP links are served by the optical layer (e.g. between P1 and P4). The served links must be constructed (step 114) by projecting the underlying optical routes onto the IP layer as an IP link. For example, referring to FIG. 16 the primary path 1402 comprises a served IP link 1604 directly between P1 and P4. Similarly, the secondary path 1404 comprises two served IP links 1606 and 1608 from P1 to P2 and from P2 to P4. In general, if five 1M services are routed along a path of the optical layer serving an IP layer link, a single 5M link is projected onto the IP layer.

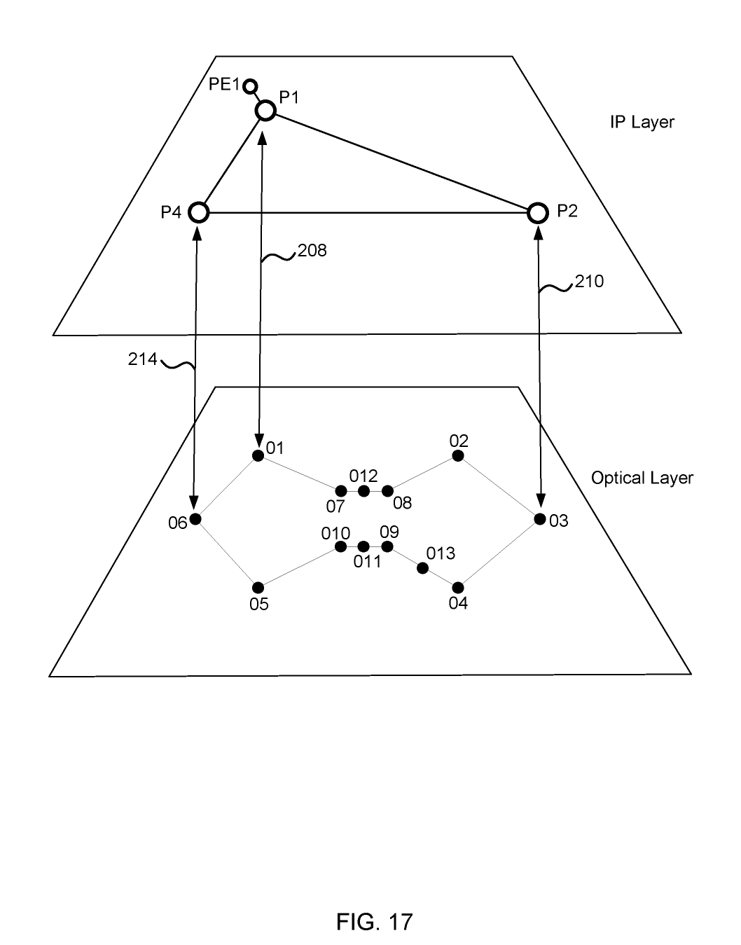

A multilayer network based on the primary and secondary paths is shown in FIG. 17. With the nodes and links of the different layers being separated out, the gateways 214, 208 and 210 between the layers are shown. Since the IP and optical layers are based on optimised paths, the layers are themselves are optimised. For simplicity, the node functionalities of the optical layer are not shown in FIG. 17. It will be appreciated that the optimised multilayer network of FIG. 17 is for illustration only and is based on a single optimum path (comprising primary and secondary paths), whereas a full optimum solution would comprise a set of paths and the optimised multilayer network would be created by projecting the set of paths onto multiple layers. A network having any number of layers may be flattened, optimised and reconstructed using this approach.

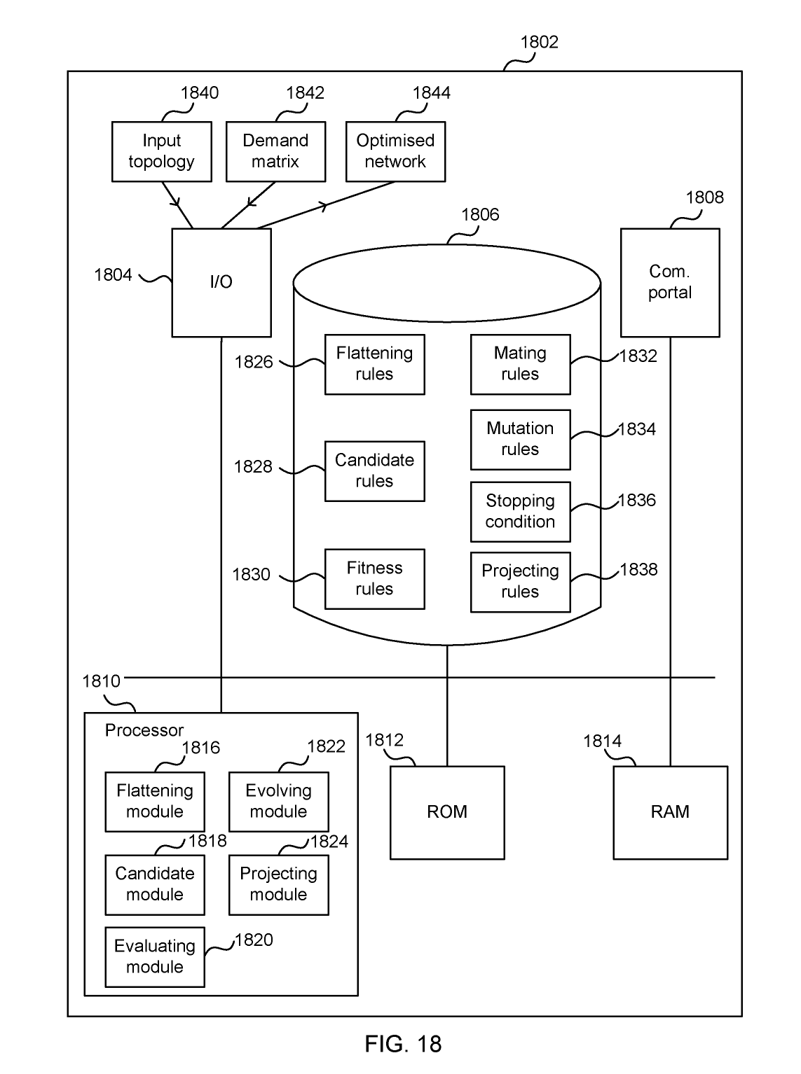

A system 1802 for modelling a multilayer network according to an embodiment of the invention is shown in FIG. 18. The system 1802 comprises an input and output interface element 1804, a database 1806, a communications portal 1808, a processor 1810, read only memory (ROM) 1812 and random access memory (RAM) 1814. The processor 1810 includes a flattening module 1816 for carrying out the step 104 of flattening the network; a candidate module 1818 for carrying out the step 108 of generating the initial candidate solutions; an evaluating module 1820 for carrying out the step 110 of evaluating the initial candidate solutions; an evolving module 1822 for carrying out the step 112 of evolving the candidate solutions; and a projecting module 1824 for projecting the optimised routing solution onto the layers of the multiple layer network, including the step 114 of constructing multilayer links such as links of an IP layer served by an optical layer.

The database 1806 stores flattening rules 1826 for instructing the flattening module 1816 how to flatten the multilayer input topology; candidate rules 1828 for instructing the candidate module 1818 how to generate the initial candidate solutions; fitness rules 1830 for instructing the evaluating module 1820 how to evaluate the initial candidate solutions using a fitness function; mating rules 1832, mutation rules 1834 and stopping condition rules 1836 for instructing the evolving module 1822 how to evolve the candidate solutions; and projecting rules 1838 for instructing the projecting module 1824 how to project the optimised routing solution onto the layers of the multiple layer network.

The interface element 1804 is arranged to receive an input topology 1840 and a demand matrix 1842 as input data and to deliver an optimised network 1844 as an output.

Functions relating to modelling a multilayer network may be implemented on computers connected for data communication via the components of a packet data network. Although special purpose devices may be used, such devices also may be implemented using one or more hardware platforms intended to represent a general class of data processing device commonly used so as to implement the event identification functions discussed above, albeit with appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. energy usage measurements for a time period already elapsed. The software code is executable by the general-purpose computer that functions as the server or terminal device used for modelling a multilayer network. In operation, the code is stored within the general-purpose computer platform. At other times, however, the software may be stored at other locations and/or transported for loading into the appropriate general-purpose computer system. Execution of such code by a processor of the computer platform or by a number of computer platforms enables the platform(s) to implement the methodology for modelling a multilayer network, in essentially the manner performed in the implementations discussed and illustrated herein.

Those skilled in the art will be familiar with the structure of general purpose computer hardware platforms. As will be appreciated, such a platform may be arranged to provide a computer with user interface elements, as may be used to implement a personal computer or other type of work station or terminal device. A general purpose computer hardware platform may also be arranged to provide a network or host computer platform, as may typically be used to implement a server.

For example, a server includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications.

A user terminal computer will include user interface elements for input and output, in addition to elements generally similar to those of the server computer, although the precise type, size, capacity, etc. of the respective elements will often different between server and client terminal computers. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

Hence, aspects of the methods of modelling a multilayer network outlined above may be embodied in programming. Program aspects of the technology may be thought of as ‘products’ or ‘articles of manufacture’ typically in the form of executable code and/or associated data that is carried on or embodied in a type of machine readable medium and/or in a plurality of such media. ‘Storage’ type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the organisation providing network modelling services into the network modelling computer platform. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible ‘storage’ media, terms such as computer or machine ‘readable medium’ refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the method of modelling a multilayer network, etc. shown in the drawings. Volatile storage media include dynamic memory, such as main memory of such a computer platform. Tangible transmission media include coaxial cables; copper wire and fibre optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Although the present invention has been described in terms of specific exemplary embodiments, it will be appreciated that various modifications, alterations and/or combinations of features disclosed herein will be apparent to those skilled in the art without departing from the spirit and scope of the invention as set forth in the following claims.

1. A system for optimising routing of traffic in a multilayer telecommunications network, the multilayer telecommunications network comprising a first layer and a second layer in which a subset of links in the first layer are served by the second layer, the system being configured to: receive network topology data describing topology of the first layer and of the second layer; receive service requirements data describing data transport services required of the multilayer telecommunications network; generate a flat model by modelling the multilayer telecommunications network as a single-layer telecommunications network, the flat model being based on the network topology data and excluding links of the first layer that are served by the second layer; optimise routing of traffic through the single-layer telecommunications network based on the service requirements data and the flat model using a routing engine; convert the optimized routes through the single-layer telecommunications network into first-layer optimized routes through the first layer of the multilayer telecommunications network and second-layer optimized routes through the second layer of the multilayer telecommunications network.

2. The system of claim 1, wherein the flat model includes gateways between the first layer and the second layer as links of the single-layer telecommunications network.

3. The system of claim 1, configured to command the multilayer telecommunications network to route traffic in the first layer according to the first-layer optimized routes and to route traffic in the second layer according to the second-layer optimized routes.

4. The system of any of claim 1, configured to receive capacity data describing free capacity of links and nodes of the multilayer telecommunications network and to optimise the routing of traffic based on the capacity data.

5. The system of claim 1, configured to remove a node or link from the flat model for failure analysis of the multilayer telecommunications network.

6. The system of claim 1, wherein the multilayer network comprises at least one of an IP layer, an Ethernet layer, an optical layer and an optical-electrical-optical layer.

7. A method of optimising routing of traffic in a multilayer telecommunications network, the multilayer telecommunications network comprising a first layer and a second layer in which a subset of links in the first layer are served by the second layer, the method comprising: receiving network topology data describing topology of the first layer and of the second layer; receiving service requirements data describing data transport services required of the multilayer telecommunications network; generating a flat model by modelling the multilayer telecommunications network as a single-layer telecommunications network, the flat model being based on the network topology data and excluding links of the first layer that are served by the second layer; optimising routing of traffic through the single-layer telecommunications network based on the service requirements data and the flat model using a routing engine; converting the optimized routes through the single-layer telecommunications network into first-layer optimized routes through the first layer of the multilayer telecommunications network and second-layer optimized routes through the second layer of the multilayer telecommunications network.

8. The method of claim 7, wherein the flat model includes gateways between the first layer and the second layer as links of the single-layer telecommunications network.

9. The method of claim 7, comprising commanding the multilayer telecommunications network to route traffic in the first layer according to the first-layer optimized routes and to route traffic in the second layer according to the second-layer optimized routes.

10. The method of claim 7, comprising receiving capacity data describing free capacity of links and nodes of the multilayer telecommunications network and optimising the routing of traffic based on the capacity data.

11. The method of claim 7, comprising removing a node or link from the flat model for failure analysis of the multilayer telecommunications network.

12. The method of claim 7, wherein the multilayer network comprises at least one of an IP layer, an Ethernet layer, an optical layer and an optical-electrical-optical layer.

13. (canceled)

14. (canceled)

15. (canceled)

16. (canceled)

17. (canceled)

18. A device comprising: a machine-readable storage medium; and executable program instructions embodied in the machine readable storage medium that when executed by a programmable system causes the system to perform a method according to claim 7.
